(19) United States
(12) Patent Application Publication
(10) Pub. No.: US 2008/0239630 A1
(43) Pub. Date: Oct. 2, 2008

(54) ELECTROLYTIC CAPACITOR

(75) Inventors: Hiroaki Izu, Osaka (JP); Takahisa Iida, Tottori-city (JP); Mutsumi Yano, Osaka (JP); Takashi Umemoto, Osaka (JP); Hiroshi Nonoue, Osaka (JP)

Correspondence Address: DITTHAVONG MORI & STEINER, P.C., 918 Prince St., Alexandria, VA, 22314, US

(73) Assignee: Sanyo Electric Co., Ltd., Moriguchi-city (JP)

(21) Appl. No.: 11/837,226

(22) Filed: Aug. 10, 2007

(30) Foreign Application Priority Data
Aug. 11, 2006 (JP) 2006-219107

(51) Int. Cl. H01G 9/042

(52) U.S. Cl. 361/528

(57) ABSTRACT

The present invention provides an electrolytic capacitor having a large electrostatic capacity.

In the solid electrolytic capacitor, a capacitor element provided with; an anode in which a part of an anode lead is embedded in the inside of an outer package made of an epoxy resin or the like; an oxide layer containing niobium oxide formed on the anode; and a cathode formed on the oxide layer; is embedded. The anode lead is composed of a niobium alloy containing at least one of vanadium and zirconium, and its one end is embedded in the anode composed of a porous sintered body of metal particles containing niobium, and the other end is connected to an anode terminal. The cathode is composed of a conductive polymer layer such as polypyrrole, a first conductive layer containing carbon particles, and a second conductive layer containing silver particles, and one end of a cathode terminal is connected to the cathode via a third conductive layer containing silver particles. Further, each other end of the anode terminal and the cathode terminal is projected out of an outer package.

### BACKGROUND OF THE INVENTION

1. Field of the Invention

The present invention relates to an electrolytic capacitor.

2. Description of the Related Art

Miniaturization and high capacity of solid electrolytic capacitors have recently been demanded, and instead of using a previous aluminum oxide or tantalum oxide as a dielectric, solid electrolytic capacitors using niobium oxide having a high dielectric constant have been proposed (see for example, Japanese Patent Laid-Open Nos. 2001-345238 and 2005-101562). These solid electrolytic capacitors are surface-mounted, for example, on print circuit boards of various electronic equipments by reflow soldering method.

FIG. 2 is a sectional view for illustrating the structure of a previous solid electrolytic capacitor. With reference to FIG. 2, the structure of the previous solid electrolytic capacitor will be illustrated.

As shown in FIG. 2, in the previous solid electrolytic capacitor, a capacitor element 102 is embedded in the inside of an outer package 101 comprising an epoxy resin or the like.

The capacitor element 102 is provided with an anode 104 in which a part of an anode lead 103 is embedded, a niobium oxide layer 105 formed on the anode 104, and a cathode 106 formed on the niobium oxide layer 105, and the niobium oxide layer 105 functions as the so-called dielectric layer.

The anode lead 103 is composed of tantalum, niobium, aluminum, titanium, or an alloy containing these metals as a principal component, and the anode 104 comprises a porous sintered body formed upon sintering niobium powder or niobium alloy powder. Also, one end of an anode terminal 107 is connected to the anode lead 103 which is projected out of the anode 104, and the other end of the anode terminal 107 is projected out of the outer package 101.

The cathode 106 is composed of a conductive polymer layer 106a comprising polypyrrole or the like formed on the niobium oxide layer 105, a first conductive layer 106b containing carbon particles formed on the conductive polymer layer 106a, and a second conductive layer 106c containing silver particles formed on the first conductive layer 106b. Further, the conductive polymer layer 106a functions as the so-called electrolyte layer.

One end of a cathode terminal 109 is connected to the cathode 106 via a third conductive layer 108 containing silver particles, and the other end of the cathode terminal 109 is projected out of the outer package 101. In this way, the previous solid electrolytic capacitor is constructed.

However, in the above-mentioned previous electrolytic capacitor, there was a disadvantage in that stress occurred between the anode lead 103 and the anode 104, for example, during heat treatment in the reflow step or during molding step for covering the capacitor element 102 with the outer package. For this reason, detachment or crack easily occurs between the anode lead 103 and the anode 104, whereby the anode 104 and the cathode 106 are contacted with each other, resulting in problematic increase of leakage current.

### SUMMARY OF THE INVENTION

The present invention has been accomplished in order to solve the above-mentioned problem, and it is an object of the present invention to provide an electrolytic capacitor having a low leakage current.

An electrolytic capacitor according to the present invention comprises: a cathode; an anode containing niobium; an oxide layer containing niobium oxide and being disposed between the cathode and the anode; and an anode lead connected to the anode, wherein the anode lead contains niobium and further contains at least one of vanadium and zirconium.

In the electrolytic capacitor according to the present invention, the concentration of vanadium and zirconium contained in the anode lead is preferably within a range of 0.1 to 10% by weight. Further, the concentration of vanadium and zirconium in the anode lead can be defined in terms of a ratio of weights of vanadium and zirconium to the sum of weights of niobium, vanadium and zirconium contained in the anode lead.

In the electrolytic capacitor according to the present invention, nitrogen is preferably contained in the anode lead.

In the electrolytic capacitor according to the present invention, the concentration of nitrogen contained in the anode lead is preferably within a range of 0.05 to 1000 ppm. Further, the concentration of nitrogen in the anode lead can be defined in terms of a ratio of weight of nitrogen to the sum of weights of niobium, vanadium, zirconium, and nitrogen contained in the anode lead.

In the electrolytic capacitor according to the present invention, the anode is preferably composed of a sintered body of metal particles containing niobium, and a part of the anode lead is embedded in the sintered body.

In the electrolytic capacitor according to the present invention, the cathode, the anode and the oxide layer are preferably covered with an outer package.

Since in the electrolytic capacitor according to the present invention, at least one of vanadium and zirconium is, as mentioned above, further added to the anode lead containing niobium, adhesion between the anode lead and the anode containing niobium can be improved. Thereby, since detachment or crack does not occur easily, for example, in the heat treatment during the reflow soldering step or in the molding step for covering the capacitor element with an outer package, contact of the anode with the cathode can be suppressed. As the result, increase of leakage current can be suppressed and an electrolytic capacitor having a low leakage current can be obtained.

Moreover, in the present invention, since nitrogen is contained in the anode lead, adhesion between the anode lead and the anode is further improved, thereby making it possible to reduce the leakage current.

Furthermore, in the present invention, a highly reliable electrolytic capacitor can be obtained by covering the electrolytic capacitor with an outer package, because it is hard to be influenced by surrounding environment.

### BRIEF DESCRIPTION OF THE DRAWINGS

FIG. 1 is a sectional view for illustrating the structure of a solid electrolytic capacitor according to a first embodiment of the present invention; and

FIG. 2 is a sectional view for illustrating the structure of a previous solid electrolytic capacitor.

### DETAILED DESCRIPTION OF THE PREFERRED EMBODIMENTS

Hereinafter, embodiments of the present invention will be illustrated with reference to the drawings.

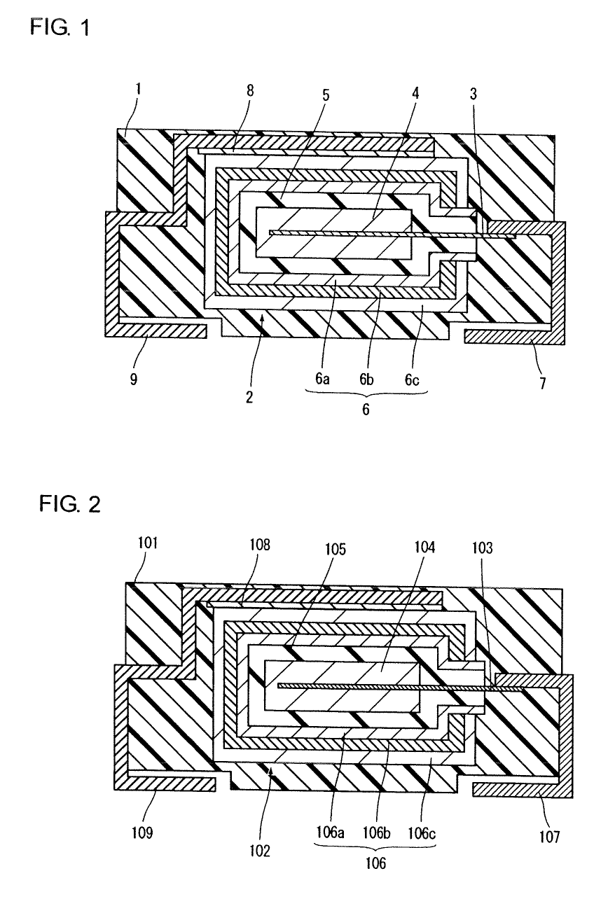

FIG. 1 is a sectional view for illustrating the structure of a solid electrolytic capacitor according to a first embodiment of the present invention. Referring to FIG. 1, the structure of a solid electrolytic capacitor according to a first embodiment of the present invention will be illustrated.

In a solid electrolytic capacitor according to a first embodiment of the present invention, a capacitor element 2 is embedded in the inside of a rectangular parallelepiped outer package 1 comprising an epoxy resin or the like, as shown in FIG. 1.

The capacitor element 2 is provided with an anode 4 in which a part of an anode lead 3 is embedded, an oxide layer 5 containing niobium oxide formed on the anode 4, and a cathode 6 formed on the oxide layer 5. Also, the oxide layer 5 functions as the so-called dielectric layer.

The anode lead 3 is a metal wire having a diameter of about 0.2 mm, and is composed of a niobium alloy containing at least one of vanadium and zirconium. Further, the anode 4 comprises a rectangular parallelepiped porous sintered body formed by sintering niobium-containing metal particles having an average particle size of about 2 μm. One end of the anode lead 3 is embedded in the center of the anode 4, thereby connecting the anode lead 3 to the anode 4. One end of an anode terminal 7 is connected to the other end of the anode lead 3 projected out of the anode 4. Further, the other end of the anode terminal 7 is projected out of the outer package 1.

A cathode 6 is composed of a conductive polymer layer 6a comprising polypyrrole, polythiophene or the like formed on the oxide layer 5, a first conductive layer 6b containing carbon particles formed on the conductive polymer layer 6a, and a second conductive layer 6c containing silver particles formed on the first conductive layer 6b. Further, the conductive polymer layer 6a functions as the so-called electrolyte layer.

One end of a cathode terminal 9 is connected to the cathode 6 via a third conductive layer 8 containing silver particles, and the other end of the cathode terminal 9 is projected out of the outer package 1. In this way, a solid electrolytic capacitor according to a first embodiment of the present invention is constructed.

Next, a manufacturing process of a solid electrolytic capacitor according to a first embodiment of the present invention will be illustrated with reference to FIG. 1.

In the solid electrolytic capacitor according to the first embodiment of the present invention, a molded product of rectangular parallelepiped is first formed from metal particles containing niobium, and at the same time, one end of the anode lead 3 is embedded in this molded product. Subsequently, the molded product is sintered in vacuum at about 1200° C. for about 20 minutes to embed a part of the anode lead 3, thereby connecting the anode lead 3 to the anode 4.

Next, anodic oxidation is carried out by immersing the anode 4 into about 0.1% by weight of aqueous phosphoric acid solution that was kept at a temperature of about 60° C. and applying a constant voltage of about 10V for about 10 hours, thereby to form the oxide layer 5 containing niobium oxide on the surface of the anode 4.

Next, the conductive polymer layer 6a is formed on the oxide layer 5 by various polymerization methods. During the polymerization procedure, the conductive polymer layer 6a is formed so as to cover the periphery of the oxide layer 5, as well as to embed the periphery or inside concave portion of the anode 4 comprising a porous sintered body. Further, by applying carbon paste containing carbon particles so as to cover the periphery of the conductive polymer layer 6a and then drying, the first conductive layer 6b containing carbon particles is formed on the conductive polymer layer 6a. Moreover, by applying silver paste containing silver particles so as to cover the periphery of the first conductive layer 6b and then drying, the second conductive layer 6c containing silver particles is formed on the first conductive layer 6b. Thereby, the cathode 6 comprising the conductive polymer layer 6a, the first conductive layer 6b and the second conductive layer 6c on the oxide layer 5 is formed to make the capacitor element 2.

Next, the anode terminal 7 is connected by welding to the anode lead 3 projected out of the anode 4. Further, when the cathode 6 and the cathode terminal 9 are dried in such a state that they are tightly adhered via silver paste containing silver particles, the third conductive layer 8 containing silver particles is formed between the cathode 6 and the cathode terminal 9, whereby the cathode 6 and the cathode terminal 9 are connected via the third conductive layer 8. Finally, the capacitor element 2 in which the anode terminal 7 and the cathode terminal 9 are connected is embedded with a resin composition containing an epoxy resin, and then the resin composition is subjected to heat curing to form the outer package 1 in which the capacitor element 2 is embedded. A molding step for covering the capacitor element 2 with the outer package 1 can be carried out by transfer molding or the like. According to the method as mentioned above, a solid electrolytic capacitor in accordance with a first embodiment of the present invention is made.

In the solid electrolytic capacitor according to this embodiment, since at least one of vanadium and zirconium is further added to the anode lead 3 containing niobium, adhesion between the anode lead 3 and the anode 4 containing niobium can be improved. Thereby, since detachment or crack between the anode lead 3 and the anode 4 does not occur easily, for example, in the heat treatment during the reflow soldering step or in the molding step for covering the capacitor element 2 with the outer package 1, contact of the anode 4 with the cathode 6 can be suppressed. As the result, increase of leakage current can be suppressed and an electrolytic capacitor having a low leakage current can be obtained.

Also, in this embodiment, since the capacitor element 2 is covered with the outer package 1, it is hard to be influenced by surrounding environment, thus making it possible to make a highly reliable solid electrolytic capacitor.

Next, solid electrolytic capacitors were produced based on the above-mentioned embodiments, and evaluation thereof was performed.

### Experiment 1

In Experiment 1, solid electrolytic capacitors A1-A3 having each the same configuration as the above-mentioned embodiment were made using an anode lead comprising a niobium alloy containing about 1% by weight of vanadium, a niobium alloy containing respectively about 1% by weight of zirconium or a niobium alloy containing about 0.5% by weight of vanadium and about 0.5% by weight of zirconium. Further, a porous sintered body of niobium particles was used as an anode.

Also, solid electrolytic capacitors A4-A6 having each the same configuration as the solid electrolytic capacitor A1 were made using an anode lead comprising a niobium alloy containing about 1% by weight of tantalum, a niobium alloy containing about 1% by weight of aluminum or a niobium alloy containing about 1% by weight of titanium, respectively, in place of the anode lead comprising a niobium alloy containing about 1% by weight of vanadium.

Also, a solid electrolytic capacitor A7 having the same configuration as that of the solid electrolytic capacitor A1 was made using an anode lead comprising niobium, in place of the anode lead comprising a niobium alloy containing about 1% by weight of vanadium.

Also, a solid electrolytic capacitor A8 having the same configuration as that of the solid electrolytic capacitor A1 was made using an anode comprising a porous sintered body of niobium alloy particles containing about 1% by weight of aluminum and having an average particle size of about 2 μm, in place of the anode comprising a porous sintered body of niobium particles.

Then, after heat treatment of each of the above solid electrolytic capacitors A1-A8 was performed at about 250° C. for about 10 minutes, a constant voltage of about 5V was applied to between the anode terminal and the cathode terminal, and the leakage current after about 20 seconds was measured. The results are shown in Table 1. In the Table 1, the measurement result of the leakage current of the solid electrolytic capacitor A1 is set to 100, and the measurement results of the leakage current of other electrolytic capacitors A2-A8 are expressed in terms of standardized values.

TABLE 1

| | Anode | Anode Lead | Leakage |
|---|---|---|---|
| | Material | Material | Current |
| A1 | Nb | Nb—V | 100 |
| A2 | Nb | Nb—Zr | 133 |
| A3 | Nb | Nb—V—Zr | 93 |
| A4 | Nb | Nb—Ta | 1467 |
| A5 | Nb | Nb—Al | 1467 |
| A6 | Nb | Nb—Ti | 1600 |
| A7 | Nb | Nb | 1667 |
| A8 | Nb—Al | Nb—V | 87 |

As shown in Table 1, the solid electrolytic capacitors A1-A3 containing at least one of vanadium and zirconium in the anode lead show a lower leakage current, compared to the solid electrolytic capacitors A4-A7 using the anode lead which does not contain these elements. Also, among the solid electrolytic capacitors A1-A3, the solid electrolytic capacitor A3 shows a lowest leakage current, and the leakage current of the solid electrolytic capacitor A1 is small next to that of the solid electrolytic capacitor A3. It can be concluded from these results that vanadium is more preferable than zirconium as the metal other than niobium contained in the anode lead for reducing leakage current, and that it is still more desirable to contain both vanadium and zirconium in the anode lead.

Further, the solid electrolytic capacitor A8 containing aluminum in the anode shows a lower leakage current than the solid electrolytic capacitors A4-A7 and shows a lower leakage current than the above-mentioned solid electrolytic capacitor A3. Based on these results, it can be said that the anode in the present embodiment can be preferably composed of a niobium alloy containing a metal other than niobium.

### Experiment 2

In Experiment 2, solid electrolytic capacitors B1-B7 having each the same configuration as the solid electrolytic capacitor A1 were made using an anode lead comprising a niobium alloy containing respectively about 0.05% by weight, about 0.10% by weight, about 0.5% by weight, about 5% by weight, about 7.5% by weight, about 10% by weight, or about 12% by weight of vanadium in place of the anode lead comprising a niobium alloy containing about 1% by weight of vanadium.

Subsequently, after heat treatment of each of the above solid electrolytic capacitors B1-B7 was performed at about 250° C. for about 10 minutes, a constant voltage of about 5V was applied to between the anode terminal and the cathode terminal, and leakage current after about 20 seconds was measured. The results are shown in Table 2. In the Table 2, the measurement result of the leakage current of the solid electrolytic capacitor A1 is set to 100, and the measurement results of the leakage current of other solid electrolytic capacitors B1-B7 are expressed in terms of standardized values.

TABLE 2

| | Vanadium | Leakage |
|---|---|---|
| | Content (wt %) | Current |
| B1 | 0.05 | 600 |
| B2 | 0.10 | 200 |
| B3 | 0.5 | 120 |
| A1 | 1 | 100 |
| B4 | 5 | 113 |
| B5 | 7.5 | 200 |
| B6 | 10 | 233 |
| B7 | 12 | 500 |

As shown in Table 2, all of the solid electrolytic capacitors B1-B7 and A1 show a lower leakage current, compared to the solid electrolytic capacitors A4-A7. Particularly, the solid electrolytic capacitors B2-B6 and A1 show each a low leakage current. Based on the results, it can be said that the concentration of vanadium in the anode lead is preferably within a range of about 0.10% by weight to about 10% by weight and is more preferably within a range of about 0.5% by weight to about 5% by weight.

### Experiment 3

In Experiment 3, solid electrolytic capacitors C1-C7 having each the same configuration as solid electrolytic capacitor A2 were made using an anode lead comprising a niobium alloy containing respectively about 0.05% by weight, about 0.10% by weight, about 0.5% by weight, about 5% by weight, about 7.5% by weight, about 10% by weight, or about 12% by weight of zirconium in place of the anode lead comprising a niobium alloy containing about 1% by weight of zirconium.

Subsequently, after heat treatment of each of the above solid electrolytic capacitors C1-C7 was performed at about 250° C. for about 10 minutes, a constant voltage of about 5V was applied to between the anode terminal and the cathode terminal, and the leakage current after about 20 seconds was measured. The results are shown in Table 3. In the Table 3, the measurement result of the leakage current of the solid electrolytic capacitor A1 is set to 100, and the measurement results of the leakage current of each of other solid electrolytic capacitors C1-C7 are expressed in terms of standardized values.

TABLE 3

| | Zirconium | Leakage |
|---|---|---|
| | Content (wt %) | Current |
| C1 | 0.05 | 685 |
| C2 | 0.10 | 290 |
| C3 | 0.5 | 155 |
| A2 | 1 | 133 |
| C4 | 5 | 175 |
| C5 | 7.5 | 220 |
| C6 | 10 | 310 |
| C7 | 12 | 640 |

As shown in Table 3, all of the solid electrolytic capacitors C1-C7 and A2 show a lower leakage current, compared to the solid electrolytic capacitors A4-A7. Particularly, the solid electrolytic capacitors C2-C6 and A2 show a low leakage current. Based on the results, it can be said that the concentration of vanadium in the anode lead is preferably within a range of about 0.10% by weight to about 10% by weight and is more preferably within a range of about 0.5% by weight to about 5% by weight.

Moreover, if the results of Experiment 2 and Experiment 3 are compared, the leakage current in Experiment 2 is lower than that in Experiment 3. For reducing the leakage current, it can be concluded from these results that vanadium is more preferable than zirconium as the metal other than niobium contained in the anode lead for reducing leakage current.

### Experiment 4

In Experiment 4, an anode lead comprising a niobium alloy containing about 1% by weight of vanadium was subjected to nitriding by performing heat treatment under nitrogen atmosphere at about 600° C. for about 1 minutes, about 5 minutes, about 10 minutes, about 15 minutes, about 20 minutes, about 30 minutes, about 40 minutes, about 50 minutes, about 60 minutes or about 65 minutes, respectively.

Then, solid electrolytic capacitors D1-D10 having each the same configuration as the solid electrolytic capacitor A1 were made using the above anode leads.

Subsequently, after heat treatment of each of the above solid electrolytic capacitors D1-D10 was performed at about 250° C. for about 10 minutes, a constant voltage of about 5V was applied to between the anode terminal and the cathode terminal, and the leakage current after about 20 seconds was measured. The results are shown in Table 4. In the Table 4, the measurement result of the leakage current of the solid electrolytic capacitor A1 is set to 100, and the measurement results of the leakage current of each of other solid electrolytic capacitors D1-D10 are expressed in terms of standardized values.

Further, with respect to the anode leads utilized for the above solid electrolytic capacitors D1-D10, nitrogen concentration in each anode lead was quantified by thermal conductivity method according to JIS G1228. That is, a part of each anode lead as a sample is placed in a graphite crucible, and heated to 2500° C. under helium atmosphere. After that, the released nitrogen gas was quantified with a thermal conductivity detector. The results are shown in Table 4.

TABLE 4

| | Nitrogen | Leakage |
|---|---|---|
| | Content (ppm) | Current |
| A1 | 0 | 100 |
| D1 | 0.03 | 100 |
| D2 | 0.05 | 92 |
| D3 | 0.1 | 53 |
| D4 | 1 | 47 |
| D5 | 10 | 33 |
| D6 | 100 | 40 |
| D7 | 500 | 53 |
| D8 | 750 | 60 |
| D9 | 1000 | 67 |
| D10 | 1200 | 107 |

As shown in Table 4, the nitrogen contents in the solid electrolytic capacitors D1-D10 are about 0.03 ppm, about 0.05 ppm, about 0.1 ppm, about 1 ppm, about 10 ppm, about 100 ppm, about 500 ppm, about 750 ppm, about 1000 ppm, and about 1200 ppm, respectively, and the solid electrolytic capacitor A1 does not contain nitrogen.

Also, all of the solid electrolytic capacitors D1-D10 and A1 show a lower leakage current, compared to the solid electrolytic capacitors A4-A7. Particularly, the solid electrolytic capacitors D2-D9 show a low leakage current. Based on the results, it can be concluded that the nitrogen concentration in the anode lead is preferably within a range of about 0.05 ppm to about 1000 ppm and is more preferably within a range of about 1 ppm to about 100 ppm.

Further, in the solid electrolytic capacitors D1-D10, the anode leads obtained by nitriding through heat treatment under nitrogen atmosphere are used. From this reason, in these anode leads, the nitrogen concentration of the surface is higher than that of the inside. As the result, it is considered that adhesion between the anode lead and the anode can be effectively improved.

The presently disclosed embodiments are to be considered in all respects only as illustrative and not restrictive. The scope of the present invention is indicated by the claims, rather than by the description of the above embodiments, and all changes which come within the meaning and range of equivalency of the claims are to be embraced within their scope.

For example, the anode may take a foil form or a plate form as well as a porous sintered body. Also, the anode lead may take a foil form or a plate form as well as a wire. Further, although the anode lead is embedded in the anode, the present invention is not limited thereto, but the anode lead may be connected to the surface of the anode.

Further, when using a niobium alloy as an anode material, a metal other than aluminum, such as tantalum, titanium, and the like may also be added.

Moreover, although the above-mentioned embodiment uses a conductive polymer layer 6a which comprises polypyrrole, polythiophene or the like as a part of the cathode 6, the present invention is not limited thereto and may use a conductive layer comprising other conductive material such as manganese dioxide in place of the conductive polymer layer 6a.

Furthermore, although the solid electrolytic capacitors are made using a conductive polymer layer 6a comprising polypyrrole, polythiophene or the like in the above embodiments, the present invention is not limited thereto, and may provide electrolytic capacitors using the common electrolytic solution utilized in aluminum electrolytic capacitors. In this case, for example, electrolytic capacitors of other embodiments of the present invention can be obtained by accommodating an anode in which an oxide layer is formed on the surface, in the inside of an outer package comprising a cylindrical container composed of aluminum or the like and further injecting an electrolytic solution into the inside of the outer package.

What is claimed is:

1. An electrolytic capacitor comprising: a cathode; an anode containing niobium; an oxide layer containing niobium oxide and being disposed between said cathode and said anode; and an anode lead connected to said anode:
wherein said anode lead contains niobium and further contains at least one of vanadium and zirconium.

2. The electrolytic capacitor according to claim 1, wherein the concentration of vanadium and zirconium contained in said anode lead is within a range of 0.1 to 10% by weight.

3. The electrolytic capacitor according to claim 1 or 2, wherein nitrogen is further contained in said anode lead.

4. The electrolytic capacitor according to claim 3, wherein the concentration of nitrogen contained in said anode lead is within a range of 0.05 to 1000 ppm.

5. The electrolytic capacitor according to any one of claims 1 to 4, wherein said cathode, said anode, and said oxide layer are covered with an outer package.
